(19) United States
(12) Patent Application Publication
(10) Pub. No.: US 2011/0131503 A1
(43) Pub. Date: Jun. 2, 2011

(54) APPARATUS AND METHODS FOR PROVIDING TARGETED ADVERTISING FROM USER BEHAVIOR

(75) Inventor: William W. Graham, JR., Mill Valley, CA (US)

(73) Assignee: CBS INTERACTIVE, INC., San Francisco, CA (US)

(21) Appl. No.: 13/016,538

(22) Filed: Jan. 28, 2011

Related U.S. Application Data
(63) Continuation-in-part of application No. 12/942,823, filed on Nov. 9, 2010.
Application No. 12/942,823 is a continuation-in-part of application No. 12/559,455, filed on Sep. 14, 2009.

(51) Int. Cl. G06F 3/01; G06F 15/16

(52) U.S. Cl. 715/744

(57) ABSTRACT

Various embodiments for providing content targeted according to user behavior are described. In one or more embodiments, a content optimizing service may be invoked by a client operating a browser application when the browser loads a web page from a web site. The content optimizing service may collect behavior events and compare the collected behavior to a set of rules. When behavior matches a rule, the user may be associated with a segment, which may be provided to a content source that selects content according to the segment. Other embodiments are described and claimed.

### RELATED APPLICATIONS

This application is a continuation-in-part of U.S. application Ser. No. 12/942,823, filed Nov. 9, 2010, entitled “Apparatus and Methods for Providing Targeted Advertising from User Behavior,” and is a continuation-in-part of U.S. application Ser. No. 12/559,455, filed Sep. 14, 2009, entitled “System and Method for Delivering Targeted Content to a User”, both of which are incorporated herein by reference in their entirety.

### BACKGROUND

Some web sites, in addition to serving their own content, display additional content, such as advertisements, from other sources. The selection of what additional content to display may be based on contextual criteria, such as page content. In the case of advertisements, advertisers may wish to place specific ads in specific contexts, and may pay for advertising space based on the various contextual criteria. However, this context is limited in that it does not take into consideration the behavior of the particular user viewing the page. Different users may arrive at the same web page for different reasons. Accordingly, there may be a need for an improved apparatus and methods for providing targeted content from user behavior.

### BRIEF DESCRIPTION OF THE DRAWINGS

FIG. 1 illustrates a system for providing targeted content in accordance with one or more embodiments.

FIG. 2 illustrates a second system for providing targeted content in accordance with one or more embodiments.

FIG. 3 illustrates a content optimizing system in accordance with one or more embodiments.

FIG. 4 illustrates a logic flow in accordance with one or more embodiments.

FIG. 5 illustrates a logic flow in accordance with one or more embodiments.

FIG. 6 illustrates a computing architecture in accordance with one or more embodiments.

### DETAILED DESCRIPTION

Various embodiments are directed to providing additional content on a web page where the additional content is targeted according to a user's online behavior. Embodiments may include a content optimizing service that is invoked from a client when the client loads a web page from a web site. The content optimizing service collects behavior events and compares the collected behavior to a set of rules. When behavior matches a rule, the user may be associated with a segment, which may be provided to a content optimizing service. The content optimizing service may select content for the user based on the segment.

Prior attempts to address content optimizing have used a proxy server to receive requests for a web page from a user. The proxy server selects a segment for the user based on information received in the page request. The proxy server would then pass the segment to the web page site so that the site could assemble the requested page customized to the user with content selected according to the segment. This approach may work well when the proxy server and the web site are centrally hosted, but breaks down when the web site and the proxy server are not hosted from the same server. This occurs, for example, when the web site, referred to as the origin server, is registered with one or more edge cache servers. That is, the origin server registers its domain in the domain name service (DNS) to point to the Internet Protocol (IP) address(es) of the edge cache provider. Edge cache servers may be situated in a distributed fashion geographically. When a user directs a browser to the origin site, the browser navigates to the edge cache server registered to the origin server domain. The edge cache server will serve the content from the requested page if the content exists in the edge cache server's cache. If the content does not exist, then the edge cache server fetches the content from the origin server and provides it to the requesting browser. In such a scenario, the user never reaches the origin server directly, and the proxy server would not be able to intercept the request.

Embodiments of the invention may solve this and other issues by using a web service, e.g. a content optimizing service, rather than a proxy server. The content optimizing service may be invoked either from the client when the client receives content from a web site, or from the web site itself. The client may receive at least some default content which may be modified or supplemented by optimized content received separately from the content optimization. In this way, optimized content may be delivered even when the content optimizing service and the web page are hosted on different servers.

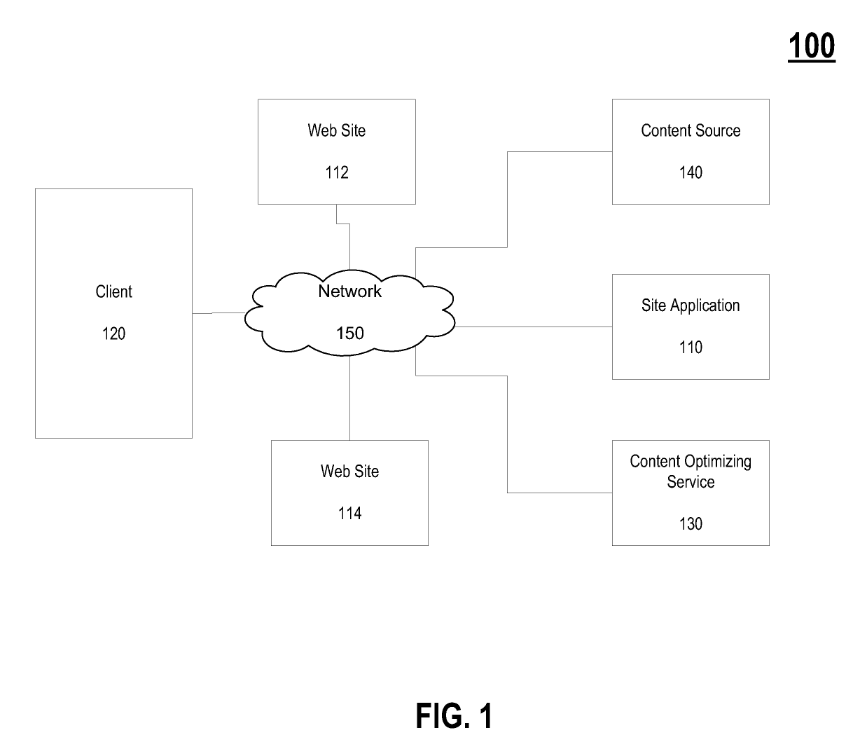

FIG. 1 illustrates a system 100 to provide targeted content based on a user's behavior. In one embodiment, for example, the system 100 may comprise a computer-implemented system having multiple computing entities or devices, such as site application 110, client 120, web sites 112, 114, content optimizing service 130, and content source 140. Each computing entity or device may have multiple components, such as computing components, communications components, storage components, and so forth. As used herein the terms “system” and “device” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented by one or more electronic devices. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The computing entities or devices of system 100 may be communicatively coupled via network 150, which may be implemented via various types of communications media, including wired or wireless communications media. Network 150 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The computing entities or devices of system 100 may include various types of standard communication elements designed to be interoperable with the network 150, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between computing entities or devices of system 100 can be in the form of a data packet adapted to be transmitted between two or more computer processes. The data packet may include a cookie and/or associated contextual information, for example.

In an embodiment, system 100 may include site application 110. Site application 110 may comprise a network server implementing a web site hosting application, a web browser, or other suitable application for serving content to clients, such as client 120. A web site may include one or more web pages of text, images, video, audio, hyperlinks, and/or other content types formatted to be viewed in an application such as a web browser, for example, Internet Explorer by Microsoft Corp., Safari by Apple Inc., or Chrome by Google. The pages may include, for example, hypertext markup language (HTML) coded pages, extensible markup language (XML) coded pages, JAVA applets, plain text, and so forth, or a combination thereof. Site application 110 may serve a number of different web pages containing varied content. The content may include default content that is served to all users, or that is served in the absence of any additional information received or detected about the user's previous on-line behavior. The web pages of the web site served by the site application 110 may have data associated with them, such as a page type, a page category, a site identifier, an asset, metadata, or other information. Examples for a page type may include a search page, a content page, a review page, a download page, and so forth. A page category may refer to the content of the page, e.g. what the page is about, such as a specific product or a topic. A site identifier may identify the parent site for the page. An asset may refer to a product or service. In some cases, the site application 110 may be operated by an entity, such as a corporation, association, or individual, and hosted primarily from one network address.

The content may include dynamically adjusted content that may be selected for display to a client according to information about the user derived from the user behavior online. In an embodiment, the dynamically adjusted content may be provided by a source other than site application 110, such as from content source 140.

A site application 110 may include many types of web sites, such as, without limitation, a news site, an online storefront, a consumer product information site, a blog, a social networking site, a gaming site, a user forum site, an entertainment site, a sports site, a professional sports site, a college sports site, a high school sports site, a financial services site, a financial products site, and other web sites aggregating a certain type or genre of information.

In an embodiment, system 100 may include client 120. Client 120 may be a wired or wireless computing device operating a browser, application viewer or other application program suitable for receiving and displaying content served by site application 110. Client 120 may receive and respond to control directives from a user, for example, input from an input device that causes the browser to connect to a specific web site, download a file, fill out a form, follow a hyperlink, etc. Client 120 may receive and store information about the user's behavior online. For example, client 120 may store a browser history for a browser application operating on client 120. The browser history may maintain a list of all of the web site addresses or uniform resource locators (URLs) visited by the user within a certain time period. Client 120 may receive and store cookie files from web sites visited, such as from web sites 112, 114. The cookie files may record actions taken at a particular web site, including links followed, search strings entered, a product purchased, and/or metadata associated with the web pages visited at the web site. Client 120 may also keep a record of input commands received from a user, output presented on a display for the user, biometric information about the user, sensor information for various sensors implemented by the client 120 (e.g., proximity sensors, motion sensors, environmental sensors, and so forth), applications executing on the client 120, state information for the client 120, and any other information that may assist in predicting or identifying the user's behavior online. Additionally or alternatively, another network device may record information about the user's behavior online, such as web site 112, web site 114, the site application 110, the content optimizing server 130, or the content source 140, for example. The embodiments are not limited to these examples.

In an embodiment, system 100 may include one or more web sites, such as web sites 112, 114. Web sites 112, 114 may be operated by entities different from the entity that operates site application 110, and different from each other. In another embodiment, web site 112 and/or web site 114 may be operated by the same entity as that of site application 110. In an embodiment, web sites 112, 114 may cooperate with site application 110 to provide contextual information to site application 110 about what actions client 120 took at web site 112 or 114. In another embodiment, web sites 112 or 114 may be “unaware” of site application 110 and may not provide such information.

In an embodiment, system 100 may include content optimizing service 130. Content optimizing service 130 may collect information about user behavior online, and may compare the collected behavior events against a set of rules in order to classify the user in one or more segments. A segment may represent a specific target audience. A segment may represent, for example, a demographic, e.g. 18-25 year-old men; an advertising category, e.g. football fan; an interest category, e.g. software development; a product category, e.g. digital camera; and so forth. Content optimizing service 130 may provide the segment information to site application 110. The segment may be used to select which content to display to the user at site application 110.

In an embodiment, content optimizing service 130 may be invoked when a client, such as client 120, initiates a connection to site application 110, for example, by requesting and loading a web page from site application 110. In an embodiment, content optimizing service 130 may be invoked from client 120 when the client begins loading the web page from site application 110. The web page may contain a script, such as a Javascript, that runs when the client loads the web page. The script may invoke content optimizing service 130. In an embodiment, content optimizing service 130 may be invoked by the requested web page from site application 110.

When content optimizing service 130 is invoked, the content optimizing service 130 may receive, from the invoking web page or client, information such as a category, a page type, a site identifier, and/or an identifier for an asset associated with the invoking web page. Other information that may be provided to content optimizing service 130 may include, for example, the uniform resource locator (URL) of the referring web page, an edition or version of the invoking web page, and an asset type of the asset associated with the current web page. Content optimizing service 130 may store some or all of the received information as behavior events.

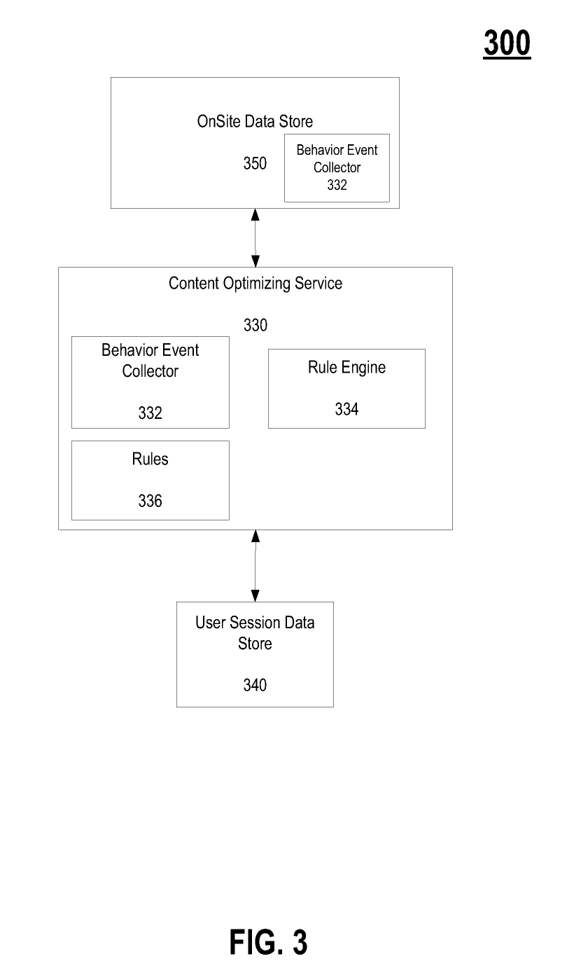

In an embodiment, content optimizing service 130 may be a representational state transfer (REST) architecture application program interface (API). Content optimizing service 130 may be invoked as a REST API by site application 110, or by the client browser, when a user loads a web page on client 120. For example, when client 120 requests to load the page content of a web page at site application 110, the requested page may contain code or a procedure that calls content optimizing service 130 using the API provided. The API may require that the call contain some input parameters about the calling web page, such as, for example, a site ID, a page category, a page type, and so forth. The API may also allow for optional parameters, such as the URL of the calling page, a version of the calling page, and so forth. Content optimizing service 130 is discussed in further detail below with respect to FIG. 3.

In an embodiment, system 100 may include at least one content source 140. Content source 140 may be in communication with site application 110, for example, via network 150. Content source 140 may receive the segment information from content optimizing service 130 via site application 110, and may use the segment to select content to insert into the content served by site application 110 and displayed to client 120, or present separately from the content served by the site application 110, such as in a separate graphical user interface (GUI) view or web page.

In an embodiment, content source 140 may be a website itself, which selects content to display at site application 110. In another embodiment, content source 140 may store and provide content to site application 110 without being accessible independently via network 150.

Content source 140 may store and provide content from a plurality of independent sources and select, as a service, which content to provide to site application 110 based on segment information. Content source 140 may be operated by the same entity as for site application 110, or may be independent. In general, the entity or entities that provide content via content source 140 desire to display their content to a more specific audience. In an embodiment, content source 140 may specify the categories of target audience, e.g. the segments that it is interested in. In another embodiment, site application 110 and/or content optimizing service 130 may specify the segments that content source 140 may then select from. The embodiments are not limited in this context.

In general, content source 140 may store content information appropriate for supplementing content information provided by the site application 110. The content information may comprise any multimedia information, including text, audio, video, images, pictures, graphics, icons, and so forth. In some cases, the content information from the content source 140 may be related to the content information provided by the site application 110. In an embodiment, for example, content source 140 may be an advertising service, and the content that is selected according to the segment may include advertising. In another embodiment, content source 140 may be a media provider, and the content selected may include movie trailers, video files, television programs, full-length movies, music files, etc. In another embodiment, content source 140 may be a news provider or a journal, and the content selected may include articles or news items. In another embodiment, content source 140 may be a merchant of products or services, and the content selected may be advertisements or links to more information about a particular product or service. The embodiments are not limited to these examples.

In an embodiment, site application 110 may be unaware of content optimizing service 130. Instead, pages served by site application 110 may contain a script that inspects the site application page and calls content optimizing service 130 from client 120. Content optimizing service 130 may determine the segment for the user, and return the segment to client 120, which may pass the segment to content source 140.

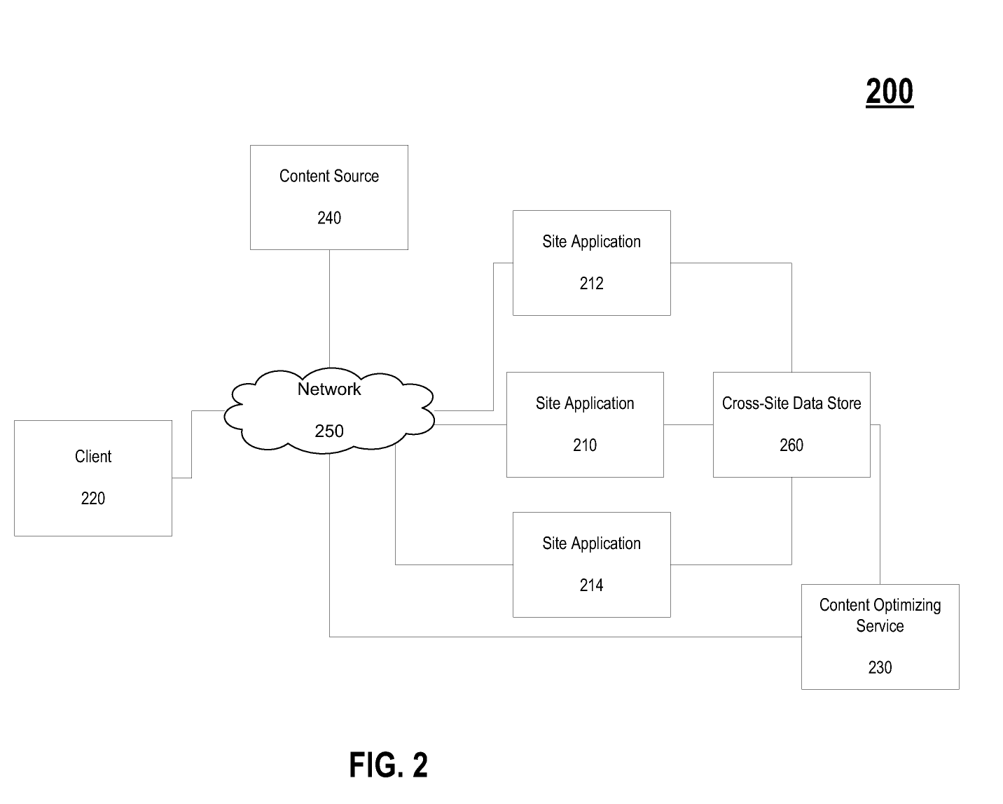

FIG. 2 illustrates a block diagram of a system 200. System 200 may be similar to system 100, with client 220, content source 240 and network 250 analogous to client 120, content source 140 and network 250, respectively. System 200 may differ from system 100 in the following ways. System 200 may comprise a plurality of site applications, e.g. site applications 210, 212, and 214. The site applications 210, 212 and 214 may each offer differing types of content. For example, site application 210 may serve news, site application 212 may serve consumer information, and site application 214 may serve an online store for products and/or services. The embodiments are not limited to these examples.

The site applications 210, 212 and 214 may each share and have access to a common cross-site data store 260. Cross-site data store 260 may store behavior events collected from some or all of the site applications 210, 212 and 214 for a given user. For example, when a user starts interacting with site application 212, content optimizing service 220 may collect and store the behavior events received, and generated by the user, at site application 212 in cross-site data store 260. When the user moves to interacting with site application 210, content optimizing service 220 may continue to collect behavior events generated by the user, and store them with the previously collected events in cross-site data store 260, indexed to the same user. In this manner, cross-site data store 260 may track user behavior across different network applications, services or devices.

In another embodiment, the site applications 210, 212 and 214 may each collect and store the behavior events for a user in cross-site data store 260. The stored events may be logically stored together and indexed to the same user, rather than generating multiple data stores for one user.

In an embodiment having cross-site data store 260, content optimizing service 220 may potentially have access to many more behavior events collected from a user's behavior across the site applications. Content optimizing service 220 may analyze the stored behavior events to intelligently determine past, present and future user interest in a given type of content information. Having access to more behavior events across multiple network entities may result in identifying more segments to assign to a user, a higher probability in matching a rule, and/or a higher confidence for the segment assigned. Content optimizing service 220 may provide the segment or segments determined from across the site applications to content source 240. The content provided by content source 240 may be influenced by the user's behavior at the site applications, and may be displayed to the user at the particular site application being viewed.

FIG. 3 illustrates a block diagram 300 of an embodiment of a content optimizing service 330. Content optimizing service 330 may be a representative embodiment of content optimizing service 130 or 230. Content optimizing service 330 may include one or more functional components, such as, but not limited to, behavior event collector 332 and rule engine 334. Content optimizing service 330 may further include a set of rules 336.

Behavior event collector 332 may collect behavior events associated with a user. Behavior events may include recorded or stored interactions that a user had, via client 120, with other web sites prior to arriving at site application 110, and interactions that the user has while interacting with site application 110. Behavior events may include, for example, search strings entered, links followed, files downloaded, one or more previous web sites visited before the current web site, etc. Behavior event collector 332 may collect behavior events, for example, by examining cookie files on client 120, fetching behavior events from other APIs, and/or examining the browser history for the browser in use on client 120 when client 120 accesses site application 110, among other sources of behavior information. While the user interacts with site application 110, behavior event collector 332 may continue to collect behavior events.

In an embodiment, behavior event collector 332 may use a unique user identifier (ID) to distinguish among multiple users. In some cases, the unique user ID may be made anonymous so that is may not be linked to a specific identity of a particular user for privacy concerns. The anonymous unique user ID may be assigned, for example, by site application 110 or by content optimizing service 130, 330 when client 120 first accesses site application 110. An anonymous unique user ID may be assigned by generating a new unique user ID and assigning it to the current session with a particular client. A unique user ID may be assigned based on some aspect of the client, such as a network address, or based on some aspect of the user obtained from the client, such as a login ID, e-mail address previously provided, etc. The unique user ID may be used to index behavior events for storage and retrieval.

Behavior events may be stored, for example, in user session data store 340. User session data store 340 may be a relatively short-lived data store of behavior events for a user during an active browsing session. User session data store 340 may therefore store the behavior events received or collected from a client when the client first accesses site application 110, and the behavior events that are generated while the client remains at site application 110. Once the client navigates away from site application 110, ending the session, the portion of user session data store 340 used for that user/client during the session may be released after a specified period of time, such as, for example, an hour, 24 hours, or a week. The data in user session data store 240 may be moved and stored for a longer term to onsite data store 350. Onsite data store 350 may store behavior events for a user/client over multiple sessions with site application 110. In an embodiment, onsite data store 350 may be stored in cross-site data store 260. User session data store 340 and onsite data store 350 may each be a computer-readable storage medium in communication with site application 110, and with content optimizing service 120. In an embodiment, one or both of user session data store 340 and onsite data store 350 may be a component of a computing device that operates site application 110 or content optimizing service 130.

Rule engine 334 may compare the collected behavior events to rules in rules 336 to determine whether the conditions of a rule have been met. Rule engine 334 may compare the events in user session data store 240 with rules 336. In an embodiment, if no rule in user session data store 240 matches a rule in rules 336, then rule engine 334 may examine events stored in onsite data store 350 for matching events. In an embodiment, rule engine 334 may compare events from both user session data store 340 and onsite data store 350 with rules 336. Older events, however, may have less weight in a determination of whether a rule is matched. When all of the conditions of a rule are met, the rule is matched, and the segment specified by the matched rule may be assigned to the user.

Rule engine 334 may use one or more matching algorithms to compare a behavior event to a rule condition and to determine whether the condition is met. For example, rule engine 334 may use a string comparison of the behavior event to a rule condition, if both the rule condition and the behavior event are stored as strings. Rule engine 334 may use a neural network implemented matching algorithm, or a fuzzy logic implemented matching algorithm.

A rule in rules 336 may be, for example, an XML configuration file, or may reside in a database. A rule may contain one or more conditions that must be met, whereupon the user will be assigned a segment specified by the rule. A rule may specify, for example, if (1) the user came from a search engine, e.g. Google, Yahoo, or Bing; and (2) searched for mountain bikes; then assign the segment “mountain bike enthusiast” to the user. The segment may be provided to site application 110 and passed to content source 140. Content source 140 may then provide content that relates to mountain biking to site application 110. In an embodiment, segment data for a user may also be stored in user session data store 340 and/or onsite data store 350.

A rule may have one or more conditional branches, e.g. an “if/then” branch, an “if/else” branch, and so forth. A rule with a conditional branch may be matched when all of the conditions within a branch are met. For example, a rule may specify the conditions: (1) If condition A, then (2) if condition B, then (3) assign segment C; else (4) if condition D, then (4) assign segment E. In this example, the rule may be matched either when conditions A and B are met, or when conditions A and D are met. Meeting all conditions A, B and D is not required.

In an embodiment, the rules may be configurable, for example, by an individual at site application 110. An individual at site application 110 may also create the segments that are provided to content source 140 for targeting. In an embodiment, the entity that operates site application 110 may charge content source 140 a fee for displaying the targeted content. Different revenue streams may be associated with different segments.

In an embodiment, segments may include a name and/or a unique number or identifier. The unique identifier may be supplied to the content source, instead of the name, in order to protect proprietary business information that may be contained in the name. In an embodiment, the unique identifier may be generated in a non-sequential manner in order to dissuade hacking attempts to discover the name. Additionally or alternatively, segments may be encrypted using a suitably secure cryptographic technique.

In an embodiment, behavior event collector 332 may be implemented with, or in communication with, onsite data store 350 instead of with content optimizing service 330. Onsite data store 350 may then collect the behavior events and pass the collected data to content optimizing service 330 for processing with rule engine 334.

The components of content optimizing service 330 may coordinate operations among each other. The coordination may involve the uni-directional or bi-directional exchange of information. For instance, the components may communicate information in the form of signals communicated over a communications media. The information can be implemented as signals allocated to various signal lines. In such allocations, each message is a signal. Further embodiments, however, may alternatively employ data messages. Such data messages may be sent across various connections. Examples of connections may include parallel interfaces, serial interfaces, and bus interfaces.

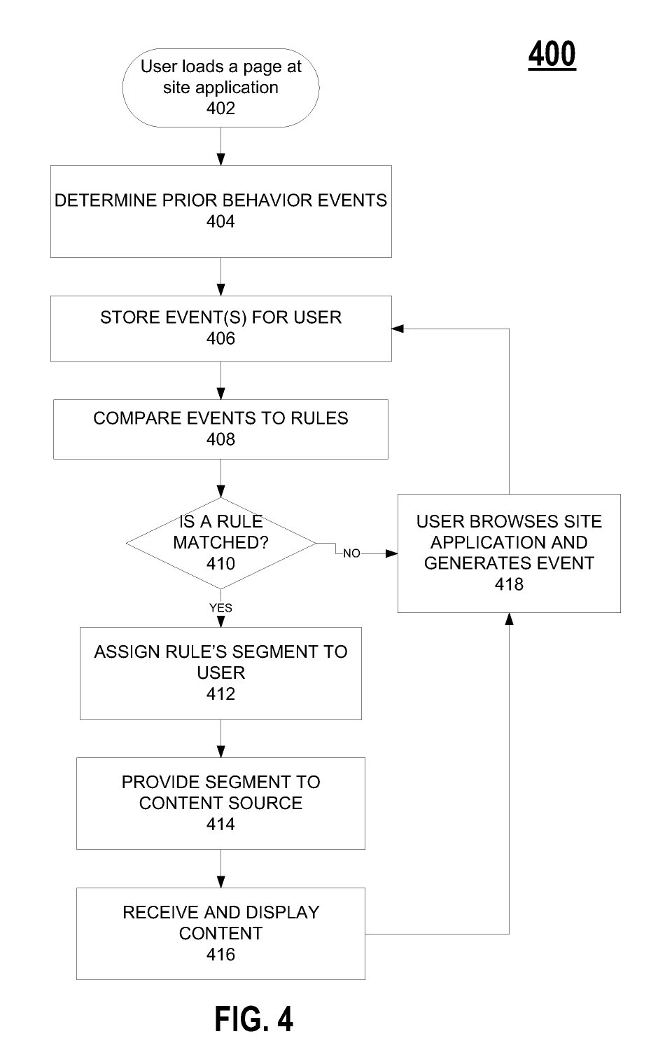

FIG. 4 illustrates a logic flow 400 in accordance with one or more embodiments. The logic flow 400 may be performed by various systems and/or devices and may be implemented as hardware, software, and/or any combination thereof, as desired for a given set of design parameters or performance constraints. For example, the logic flow 400 may be implemented by a logic device (e.g., processor) and/or logic (e.g., threading logic) comprising instructions, data, and/or code to be executed by a logic device. For purposes of illustration, and not limitation, the logic flow 400 is described with reference to FIG. 1. The embodiments are not limited in this context.

In various embodiments, the logic flow 400 may begin at block 402, when a user loads a web page from site application 110. Loading a web page from site application 402 may refer to a user directing client 120 to connect to site application 110, for example, by following a hyperlink or typing in a URL, and the client receiving at least default content from the web page served by site application 110. In an embodiment, block 402 may occur after the user has visited one or more other web sites first, such as web site 112 or 114. In another embodiment, block 402 may occur as the first action taken when a browser is launched on client 120. Upon arrival, content optimizing service 130 may be invoked by either client 120 or site application 110, and behavior event collector 332 may assign a unique user ID to the user/client.

The logic flow 400 may determine prior behavior events, if any, in block 404. For example, content optimizing service 130 or behavior event collector 332 may examine a browser history or cookies files on client 120, receive information from the invoking call from site application 110, or identify the web site where the user came from. Behavior events that may be determined may include, for example, user control directives, search strings entered, links followed, files downloaded, previous site visited before the current site, etc. In an embodiment, the time that a behavior event occurred may also be determined.

The logic flow 400 may store the behavior event(s) in block 406. The behavior events may be stored in association with the specific user. For example, the behavior events may be stored in a database or file that is indexed using the unique user ID assigned to the user. The behavior events may be stored in user session data store 340 and/or in onsite data store 350.

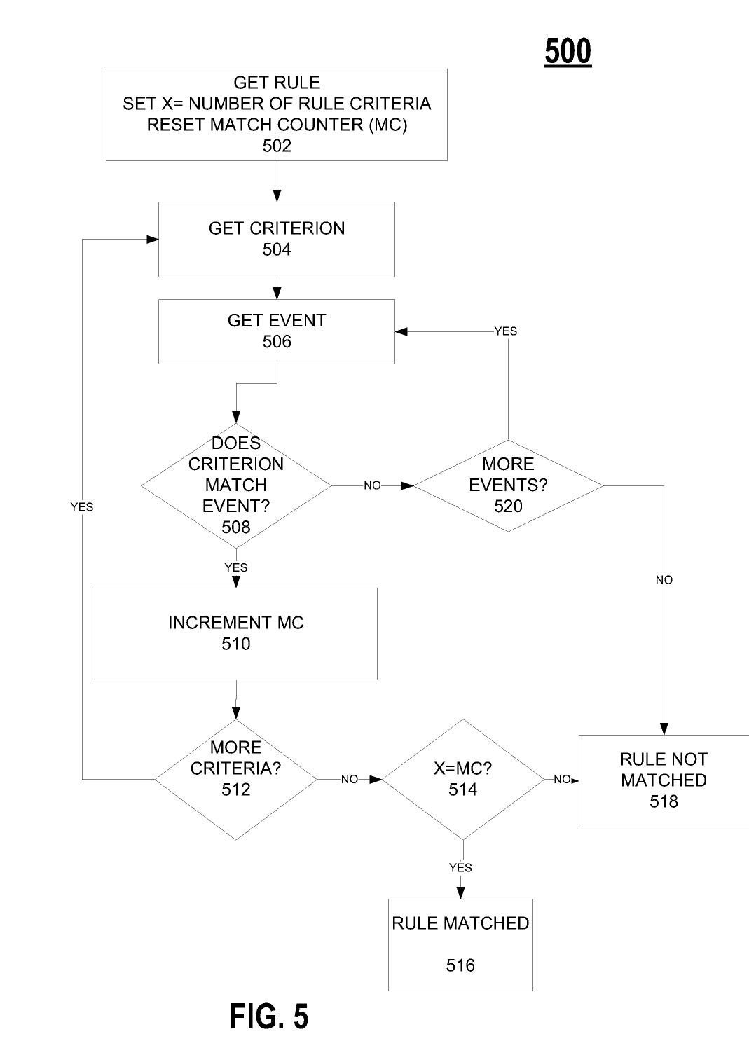

The logic flow 400 may compare the rules to the behavior events in block 408. For example, rule engine 334 may compare a rule in rules 336 to an individual behavior event or a collected behavior event comprising multiple behavior events. Rule engine 334 may compare each rule in rules 336 to all of the collected behavior events, or may stop comparing rules to behavior events when a rule is matched. If a rule contains multiple conditions, requiring multiple behavior events to occur in order to match the rule, rule engine 334 may weight recent events more heavily than older events in considering whether a rule condition is met, or utilize other prioritization or weighting rules. Block 408 is described in more detail with respect to FIG. 5.

When a rule is matched, in block 410, the logic flow 400 may assign the segment associated with the matched rule to the user in block 412. In an embodiment, blocks 408, 410 and 412 may be repeated for each rule in rules 336, which may result in assigning more than one segment to a user at a time.

The logic flow 400 may provide the segment to a content source in block 414. For example, content optimizing service 130 may provide the segment to content source 140. Content optimizing service 130 may, for example, provide the segment via site application 110, or as a return from a script call from client 120. The segment may be represented in clear-text, using a unique identifier for a segment, or an encrypted segment.

The logic flow 400 may receive and display the content from the content source in block 416. For example, content source 140 may select content according to the segment from block 412. The content may be, for example, an advertisement, an article, a link, a media file, or any other relevant information. In an embodiment, content source 140 may be a component of site application 110, and the content may be one of several versions of a web page that is selected according to the segment. A web site may, for example, have different versions of one or more pages that are targeted to different income brackets. A user that has been browsing high-end retail web sites or luxury products may be targeted with one version of a page, while a user that has been browsing lower-end retail web sites may be targeted with a different version. A web site may have different layouts of a web page to try, and may provide one version to frequent visitors of the site and a different version to new visitors. Content source 140 may provide the content directly to site application 110 according to code in the page served by site application 110. Content source 140 may provide the content via content optimizing service 130. The received content may be inserted into the display of the currently served page of site application 110.

The logic flow 400 may continue as the user browses the site application in block 418. As the user continues to generate behavior events, the events may be stored, in block 406. The logic flow 400 may proceed to block 418 from block 410 when no rules are matched from the current set of behavior events. In an embodiment, block 408 may be repeated with each new behavior event stored, or may be repeated after a specified number of behavior events is stored. The logic flow 400 may continue for as long as the user is interacting with site application 110.

FIG. 5 illustrates a logic flow 500 in accordance with one or more embodiments. Logic flow 500 may be an exemplary embodiment of block 408, matching events to rules. The embodiments are not limited to this example.

Logic flow 500 may get a rule in block 502. For example, rule engine 334 may select a rule from rules 336. Rule engine may count the number of criteria (X) needed to satisfy the rule, and may initialize a match counter to zero. The variable X may represent any positive integer. For example, if a rule states: user came from a news web site, and viewed an article in the Arts section, then the segment is “art lover”. This rule has two criteria, so X=2.

Logic flow 500 may select a criterion of the current rule in block 504. In the above example, a first criterion is “user came from a news website” and a second criterion may be “viewed an article in the Arts section.”

Logic flow 500 may select an event in block 506. In an embodiment, rule engine 334 may select the most recent behavior event, or the oldest behavior event, from user session data store 340. If there are no behavior events in user session data store 340, then rule engine 334 may check onsite data store 350 for a behavior event.

Logic flow 500 may, in block 508, determine whether the behavior event matches the current criterion. For the current example, if the behavior event is “user came from a search engine”, then the event does not match the criterion. If instead the event is “user came from a news web site,” then the event does match the criterion.

When the behavior event does match the criterion in block 508, logic flow 500 may increment the match counter to indicate that one criterion of the rule is met. When there are more criteria to meet, in block 512, logic flow may repeat blocks 504-508 for the next criterion.

When the behavior event does not match the criterion in block 508, logic flow 500 may check for more events in block 520. When there are more behavior events, in block 520, logic flow 500 may repeat blocks 506-508 for the next behavior event. When there are no more behavior events to check in block 520, then the rule is not matched, at block 518.

When there are no more criteria to match in the rule at block 512, logic flow 500 may compare the number of criteria X with the number of matches found in block 514. If the numbers match, then all of the rule criteria are met and the rule is matched in block 516. If the numbers do not match, then not all of the rule criteria were met and the rule is not matched, at block 518. In an embodiment, logic flow 500 may be repeated for each rule in rules 336, or may stop once a rule is matched in block 516.

Logic flow 500 may represent one embodiment of a rule matching process. Other embodiments may include additional or alternate blocks. For example, a rule matching logic flow may consider the age of an event when determining whether the event matches a rule criterion or deciding to use the segment of a matched rule. If an event is too old, for example, if it occurred over an hour ago, then the logic flow may continue to try to match other rules before resorting to using the rule with the old event. The logic flow may perform a numeric or statistical analysis of a user's behavior events over time, for example using the events stored in onsite data store 350. Older behavior may generally have less weight than new or current behavior. However, older consistent and repeated behavior may accumulate more weight over time and cause a segment related to that behavior to be selected.

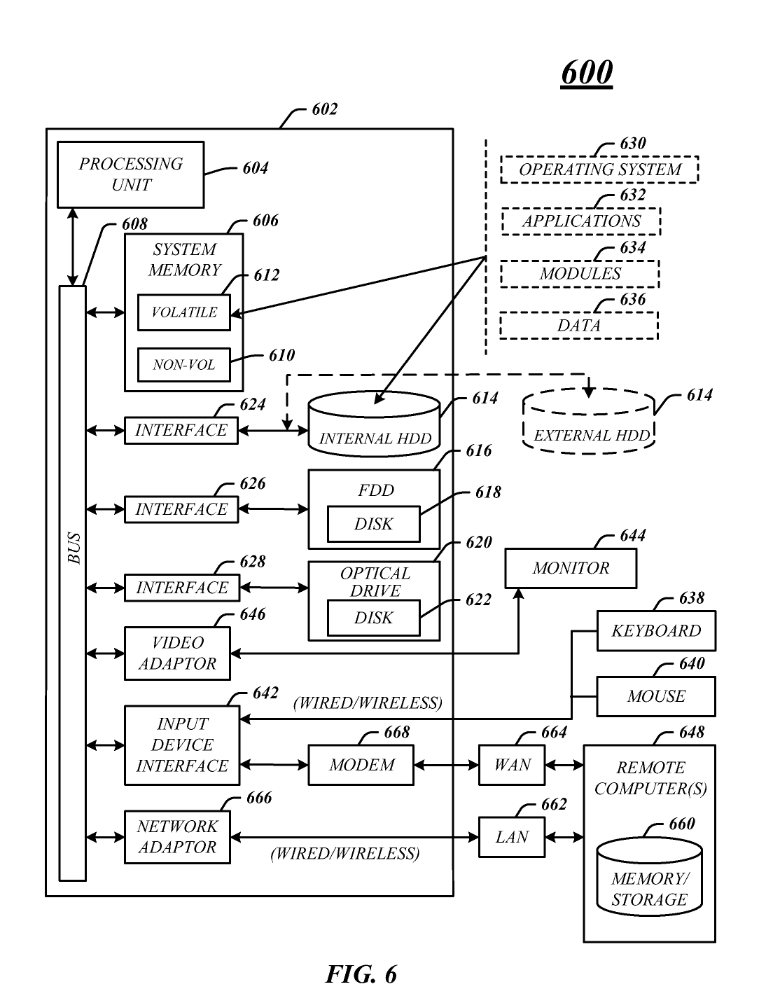

FIG. 6 illustrates a computer architecture in accordance with one or more embodiments, suitable for implementing various embodiments as previously described. The computing architecture 600 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 600.

As shown in FIG. 6, the computing architecture 600 comprises a processing unit 604, a system memory 606 and a system bus 608. The processing unit 604 can be any of various commercially available processors. Dual microprocessors and other multi-processor architectures may also be employed as the processing unit 604. The system bus 608 provides an interface for system components including, but not limited to, the system memory 606 to the processing unit 604. The system bus 608 can be any of several types of bus structure that may further interconnect to a memory bus (with or without a memory controller), a peripheral bus, and a local bus using any of a variety of commercially available bus architectures.

The system memory 606 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 6, the system memory 606 can include non-volatile memory 610 and/or volatile memory 612. A basic input/output system (BIOS) can be stored in the non-volatile memory 610.

The computer 602 may include various types of computer-readable storage media, including an internal hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. The one or more application programs 632, other program modules 634, and program data 636 can include, for example, site application 110, behavior event collector 332 and rule engine 334.

A user can enter commands and information into the computer 602 through one or more wire/wireless input devices, for example, a keyboard 638 and a pointing device, such as a mouse 640. Other input devices may include a microphone, an infra-red (IR) remote control, a joystick, a game pad, a stylus pen, touch screen, or the like. These and other input devices are often connected to the processing unit 604 through an input device interface 642 that is coupled to the system bus 608, but can be connected by other interfaces such as a parallel port, IEEE 1394 serial port, a game port, a USB port, an IR interface, and so forth.

A monitor 644 or other type of display device is also connected to the system bus 608 via an interface, such as a video adaptor 646. In addition to the monitor 644, a computer typically includes other peripheral output devices, such as speakers, printers, and so forth.

The computer 602 may operate in a networked environment using logical connections via wire and/or wireless communications to one or more remote computers, such as a remote computer 648. The remote computer 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

Various embodiments may comprise one or more elements. An element may comprise any structure arranged to perform certain operations. Each element may be implemented as hardware, software, or any combination thereof, as desired for a given set of design and/or performance constraints. Although an embodiment may be described with a limited number of elements in a certain topology by way of example, the embodiment may include more or less elements in alternate topologies as desired for a given implementation.

References to “one embodiment” or “an embodiment” mean that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. With respect to software elements, for example, the term “coupled” may refer to interfaces, message interfaces, API, exchanging messages, and so forth.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A computer-implemented method comprising:
receiving, at a content optimizing service, an invoking request from a client loading the content of a page served from a web site;
collecting behavior events from the client;
selecting a segment for the client based on the behavior events;
providing the segment to a content source for selection of content according to the segment;
receiving the selected content from the content source; and
providing the selected content to the web site for display in the page at the client.

2. The method of claim 1, further comprising:
comparing at least one rule to at least one behavior event to determine if the rule is matched; and
assigning a segment to the client when a rule is matched, wherein the segment is specified by the matched rule.

3. The method of claim 1, further comprising:
assigning a unique identifier to the client; and
storing the behavior events indexed by the unique identifier in a data store.

4. The method of claim 1, wherein a behavior event comprises at least one of: a web paged loaded, a search string entered, a hyperlink followed, a file downloaded, a form filled out, a product purchased, and metadata associated with a loaded web page.

5. The method of claim 4, wherein collecting behavior events comprises at least one of:
collecting behavior events from a cookie file stored on the client;
collecting behavior events from a browser history file; and receiving behavior events from the web site in the invoking request.

6. The method of claim 1, further comprising:
collecting behavior events from the client as long as the client is accessing the web site; and
periodically selecting a segment for the client based on the behavior events.

7. The method of claim 6, wherein the client accesses a plurality of web sites during a session, the method further comprising:
collecting behavior events from the client throughout the session;
storing the collected behavior events from the session in one data store; and
selecting the segment based on the collected behavior events in the one data store.

8. An apparatus comprising:
a processor; and
a memory to store a content optimizing service that when executed by the processor is operative to receive an invoking request from a client loading the content of a page served from a web site, receive one or more behavior events from a client, select a segment when the one or more behavior events match one or more rules, provide the segment to a content source for selection of content according to the segment, receive the selected content from the content source, and provide the selected content to the client, wherein a behavior event comprises an action taken by a user of the client at a web site.

9. The apparatus of claim 8, the content optimizing service further comprising:
a behavior event collector to collect the behavior events from the client.

10. The apparatus of claim 9, further comprising a data store, the content optimizing service further to store the behavior events in the data store.

11. The apparatus of claim 10, the behavior event collector further to collect behavior events from the client accessing a plurality of web sites in a session, and to store the collected behavior events from the session in one data store.

12. The apparatus of claim 9, the behavior event collector further to collect behavior events from the client as long as the client is accessing the web site; and
the rule engine further to periodically select a segment for the client based on the behavior events.

13. The apparatus of claim 12, wherein the content optimizing service is hosted from a different server than the web site.

14. The apparatus of claim 8, a rule engine to compare the behavior events to each rule in a set of rules until a rule is matched.

15. The apparatus of claim 8, a rule engine to compare the behavior events to each rule in a set of rules.

16. The apparatus of claim 8, a rule engine to consider the age of a behavior event when determining whether the behavior event matches a rule.

17. A computer-readable storage medium comprising instructions that when executed enable a computing system to:
receive an invoking request from a client loading the content of a page served from a site application;
collect behavior events from the client;
determine whether a behavior event matches a criterion of a rule from a set of rules;
retrieve a segment from a rule when all of the criteria of a rule are matched by one or more behavior events;
provide the segment to a content source for selection of content according to the segment;
receive the selected content from the content source; and
provide the selected content to the site application for display in a page of the site application at the client.

18. The storage medium of claim 17, further comprising instructions that when executed enable the computing system to:
assign a unique ID to the client when the client accesses the site application, wherein the unique ID is at least one of: a generated anonymous ID, and an ID generated based on one or more characteristics of the client.

19. The storage medium of claim 18, further comprising instructions that when executed enable the computing system to:
collect behavior events from the client while the client accesses a plurality of site applications; and
store the collected behavior events in one data store indexed by the unique ID.

20. The storage medium of claim 17, wherein the instructions to collect behavior events comprise instructions to at least one of:
collect behavior events from a cookie file stored on the client;
collect behavior events from a browser history file; and
receive behavior events from the site application.
